(19) United States
(12) Patent Application Publication
(10) Pub. No.: US 2025/0358264 A1
(43) Pub. Date: Nov. 20, 2025

(54) SYSTEMS AND METHODS FOR VERIFYING DEVICES USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Shahadat Hossain Mazumder, Charlotte, NC (US); Abhijit Behera, Hyderabad (IN); Maneesh Kumar Sethia, Hyderabad (IN); Sivashalini Sivajothi, Chennai (IN)

(73) Assignee: BANK OF AMERICA CORPORATION, CHARLOTTE, NC (US)

(21) Appl. No.: 18/668,386

(22) Filed: May 20, 2024

(51) Int. Cl. H04L 9/40; H04L 9/00

(52) U.S. Cl. CPC H04L 63/0428; H04L 9/008

(57) ABSTRACT

Systems, computer program products, and methods are described herein for verifying devices using advanced computational models for data analysis and automated processing. The present disclosure is configured to initiate a resource transaction, wherein the resource transaction is initiated via a sender device, and wherein the resource transaction comprises transferring a resource from a sender resource container to a receiver resource container via the sender device and a receiver device; generate a primary contract, wherein the primary contract comprises encrypting a data packet associated with the resource transaction and wherein the data packet comprises resource transaction details; generate a secondary contract, wherein the secondary contract comprises verifying the receiver device; and execute the resource transaction, wherein executing the resource transaction comprises providing the data packet to a sender entity, and wherein the sender entity is associated with the sender resource container.

### TECHNOLOGICAL FIELD

Example embodiments of the present disclosure relate to verifying devices using advanced computational models for data analysis and automated processing.

### BACKGROUND

There are many challenges associated with device verification systems. Applicant has identified a number of deficiencies and problems associated with verifying devices using advanced computational models for data analysis and automated processing. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for verifying devices using advanced computational models for data analysis and automated processing.

Embodiments of the present invention address the above needs and/or achieve other advantages by providing apparatuses (e.g., a system, computer program product, and/or other devices) and methods for verifying devices using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention initiates a resource transaction, wherein the resource transaction is initiated via a sender device, and wherein the resource transaction includes transferring a resource from a sender resource container to a receiver resource container via the sender device and a receiver device. In some embodiments, the present invention generates a primary contract, wherein the primary contract includes encrypting a data packet associated with the resource transaction and wherein the data packet includes resource transaction details. In some embodiments, the present invention generates a secondary contract, wherein the secondary contract includes verifying the receiver device. In some embodiments, the present invention executes the resource transaction, wherein executing the resource transaction includes providing the data packet to a sender entity, and wherein the sender entity is associated with the sender resource container.

In some embodiments, the primary contract further includes encrypting the data packet using homomorphic encryption.

In some embodiments, the resource transaction details include sender information, wherein the sender information includes information of a sender associated with the sender device. In some embodiments, the resource transaction details include receiver information, wherein the receiver information includes information of a receiver associated with the receiver device. In some embodiments, the resource transaction details include sender entity information, wherein the sender entity information includes information of the sender entity associated with the sender resource container. In some embodiments, the resource transaction details include receiver entity information, wherein the receiver entity information includes information of a receiver entity associated with the receiver resource container.

In some embodiments, the secondary contract further includes determining, using a public domain database, a match between the receiver information and receiver device information.

In some embodiments, the secondary contract further includes, in response to the match, generating a verification interface, wherein the verification interface is transmitted to the sender device, and wherein the verification interface configures a graphical user interface of the sender device.

In some embodiments, the secondary contract further includes, in response to a mismatch, generating a declination interface, wherein the declination interface is transmitted to the sender device, and wherein the declination interface configures the graphical user interface of the sender device.

In some embodiments, an artificial intelligence (AI) module stores the mismatch and accesses the mismatch for future resource transactions include the receiver device, wherein the AI module includes a transaction analysis unit configured to monitor the resource transaction.

In some embodiments, the resource transaction includes a distributed ledger.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for verifying devices using advanced computational models for data analysis and automated processing, in accordance with an embodiment of the disclosure;

FIG. 2 illustrates a process flow for verifying devices using advanced computational models for data analysis and automated processing, in accordance with an embodiment of the disclosure; and

FIG. 3 illustrates an example embodiment of the system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data. In some embodiments, an entity may include a receiver or a sender, wherein the receiver or the sender are part of a resource transaction. In this way, the receiver or the sender to a resource transaction may be an entity.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity. Further, as used herein, a “receiver” or a “sender” may be a user. In some embodiments, the receiver or the sender may be an individual who is part of a resource transaction.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

In the modern world, mobile to mobile payment transactions via mobile telephones have been increasing in popularity and use. With more transactions taking place through mobile to mobile systems, there is an ever-growing uncertainty of data breaches of both personal data and financial data, leading to loss of resources. Mobile to mobile payments rely on transferring the related transaction data from the sender device to the recipient device. Typically, a user of a mobile payment system initiates a transaction by inputting the recipient device's phone number. Then, the payment is electronically transferred from the sender's account to the recipient's account. However, there are many uncertainties surrounding the conventional systems that handle mobile to mobile payments. For instance, security issues of the mobile payment system are common, and the system may be vulnerable to malicious activity such as intentional interference with the payment or the like. Further, malicious third parties may mimic other telephone numbers through “spoofing” or misappropriating another individual's telephone number to gain the trust of a sender of resources. Further still, the personal data of a sender using a conventional mobile payment transaction system may be exposed, sold, or used in malicious ways as to harm the sender.

The disclosure herein provides for a system that, when a mobile-to-mobile resource transaction is initiated, a data packet containing the resource transaction details and sender details is transferred to a receiver's mobile device. A primary smart contract is generated to ensure the data packet transferred is secure through homomorphic encryption. The homomorphic encryption of the data packet does not allow tampering with the data packet. Further, a secondary smart contract is generated simultaneously when the primary smart contract is generated. The secondary smart contract ensures that the receiver of the resource transaction is verified by comparing the receiver's information and the receiver device's information against a publicly accessible database. The publicly accessible database may include the receiver's identification information and can be used to ensure the receiver and the receiver's device are legitimate. For example, the secondary contract may determine the receiver device's phone number is linked to a valid social security number of the receiver via the public database. In addition, the resource transaction processing takes place on a distributed ledger. The system also includes an artificial intelligence (AI) module that stores resource transaction details and receiver device information for future transactions. In this way, the AI module may remember failed transactions for the future, and flag them for the sender, even before the verification step is initiated.

What is more, the present disclosure provides a technical solution to a technical problem. As described herein, the technical problem includes security issues surrounding conventional mobile to mobile resource transaction systems, including issues with securitizing the resource transaction and current processes to verify intended recipients. The technical solution presented herein allows for simultaneous generation of multiple smart contracts that securitize the data packet (e.g., details of the resource transaction) and verify the receiver of the resource transaction. In particular, a device verification system (e.g., the system as described herein) is an improvement over existing solutions to the issues surrounding conventional mobile to mobile resource transaction systems, (i) with fewer steps to achieve the solution, thus reducing the amount of computing resources, such as processing resources, storage resources, network resources, and/or the like, that are being used (e.g., providing multiple simultaneous smart contracts for both encryption of the data packet and verification of the recipient), (ii) providing a more accurate solution to problem, thus reducing the number of resources required to remedy any errors made due to a less accurate solution (e.g., verifying the receiver device by comparing receiver information and the receiver device information with a public domain ensures accurate verification), (iii) removing manual input and waste from the implementation of the solution, thus improving speed and efficiency of the process and conserving computing resources (e.g., generating simultaneous smart contracts triggered by the initiation of a transaction improves speed and efficiency of verification and resource transactions), (iv) determining an optimal amount of resources that need to be used to implement the solution, thus reducing network traffic and load on existing computing resources (e.g., storing unverified receiver information reduces resources consumed for future transactions). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the device verification system as described herein is a solution to the problem of ensuring the security of the transmitted data and authenticating (e.g., verifying) the identity of the receiving user and device. Further, the device verification system may be characterized as identifying a specific improvement in computer capabilities and/or network functionalities in response to the device verification system's integration to existing devices, software, applications, and/or the like. In this way, the device verification system improves the capability of a system to effectively and efficiently increase security by verifying identities of recipients through reliable, transparent, and publicly accessible records. Further, the device verification system improves the functionality of networks in response to reducing the resources consumed by the system (e.g., network resources, computing resources, memory resources, and/or the like).

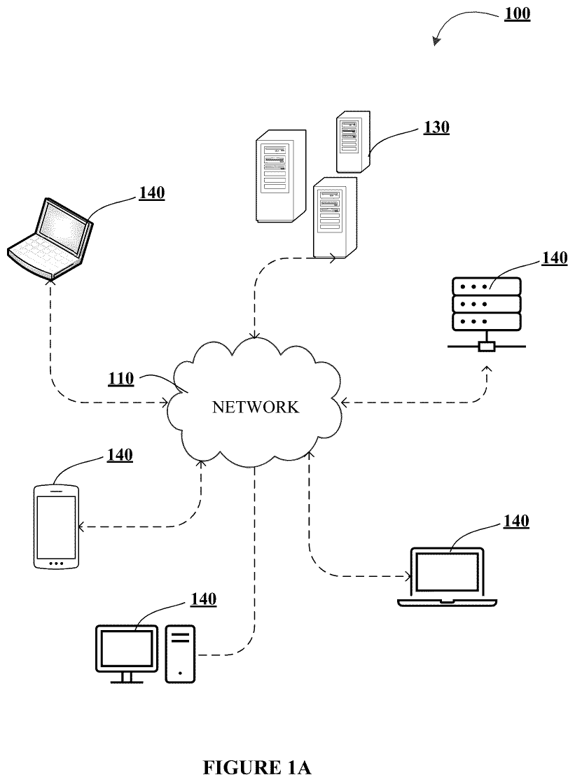

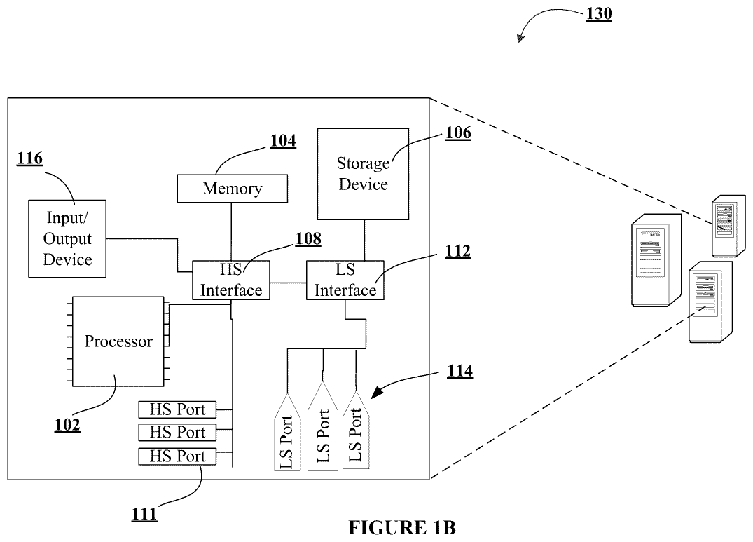

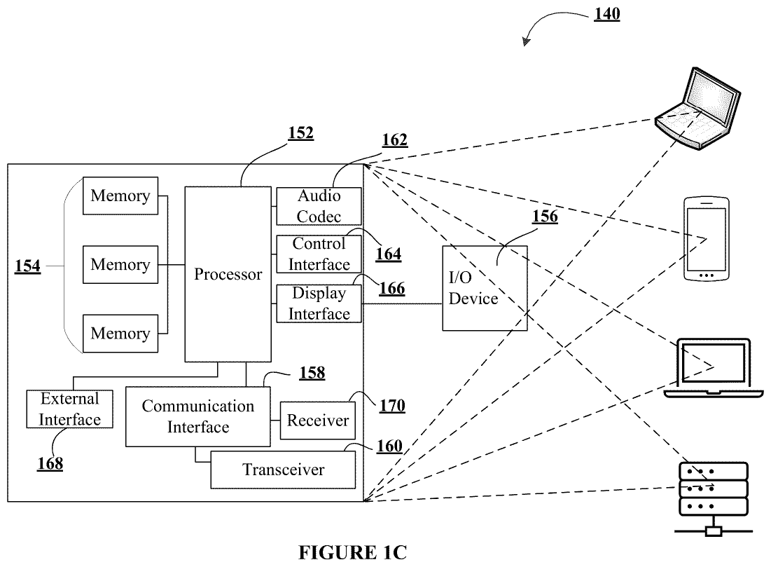

FIGS. 1A-1C illustrate technical components of an exemplary distributed computing environment 100 for verifying devices using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphone s, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

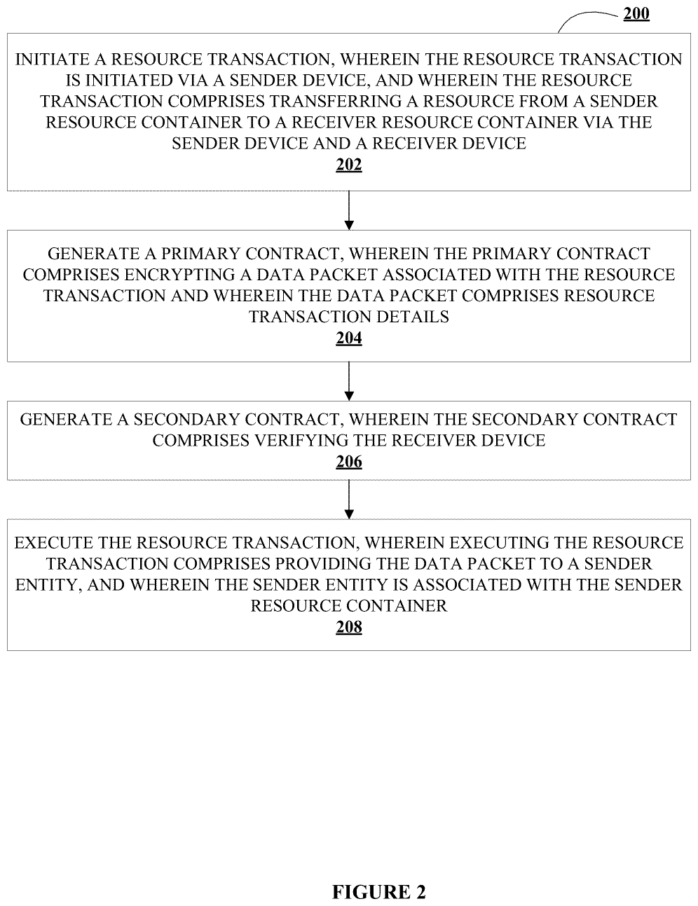

FIG. 2 illustrates a process flow for verifying devices using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a device verification system (e.g., similar to one or more of the systems described herein with respect to FIGS. 1A-IC) may perform one or more of the steps of process flow 200. For example, the device verification system (e.g., the system 130 described herein with respect to FIGS. 1A-IC) may perform the steps of process flow 200.

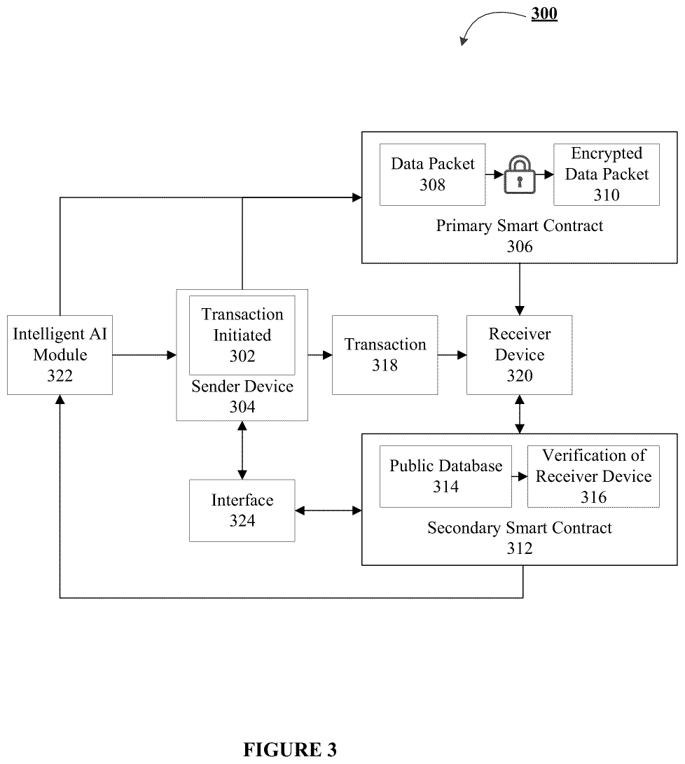

As shown in block 202, the process flow 200 of this embodiment includes initiating a resource transaction, wherein the resource transaction is initiate via a sender device, and wherein the resource transaction comprises transferring a resource from a sender resource container to a receiver resource container via the sender device and a receiver device. As described above, the resource transaction may include an exchange of resources between a sender and a receiver. The resource transaction may be initiated by the sender (e.g., an individual, an entity, a merchant, or the like) or by the receiver (e.g., an individual, an entity, a merchant, or the like). In this way, and in some embodiments, the resource transaction may be initiated by either party (e.g., sender or receiver) to the transaction. For example, and as shown in FIG. 3, the sender device 304 may initiate (as shown in block 302) the transaction 318. The resource transaction may be carried out on the devices of the sender and receiver, which may include mobile devices, tablets, computers, servers, kiosks, merchant terminal, or the like. For example, as shown in FIG. 3, the sender device 304 and the receiver device 320 may each be any of a mobile device, tablet, computer, server, kiosk, merchant terminal, or the like. In some embodiments, the resource transaction may be completed on the same device (e.g., combining the receiver device and the sender device into one common device). For example, a sender may use the receiver's merchant terminal to initiate the resource transaction.

As shown in block 204, the process flow 200 of this embodiment includes generating a primary contract, wherein the primary contract includes encrypting a data packet associated with the resource transaction and wherein the data packet includes resource transaction details. The primary contract may include instructions, obligations, or the like for the resource transaction to be completed or executed. In this way, the primary contract may include a smart contract that automatically completes the terms set out in the contract. Additionally, or alternatively, the smart contract may include self-executing contracts with the terms of the agreement directly written into lines of code. Using a decentralized network (e.g., distributed ledger) allows for the smart contracts to execute and operate in a transparent manner. Once the conditions of the smart contract are met, the smart contract may automatically enforce or execute the terms of the contract, which enhances efficiency and security of the resource transaction as described herein. In some embodiments, the conditions of the smart contract (e.g., the primary smart contract 306 as shown in FIG. 3) may include successful verification of the receiver device (e.g., the receiver device 320 as shown in FIG. 3).

As shown in FIG. 3, the primary smart contract 306 may include the data packet 308 and the encrypted data packet 310. The data packet (e.g., the data packet 308 in FIG. 3) may include the resource transaction details associated with the resource transaction and may be transmitted within the primary smart contract (e.g., the primary smart contract 306 in FIG. 3).

The encryption of the data packet may include encrypting the resource transaction details contained in the data packet. Further, the primary contract may include encryption methods to securitize the data packet being transmitted. In some embodiments, the primary contract further includes encrypting the data packet using homomorphic encryption. As used herein, homomorphic encryption may include an encryption method that allows for computations on the encrypted data without the need to decrypt the data first. Using homomorphic encryption enables secure processing of the data while maintaining privacy of the data during transfer.

In some embodiments, the homomorphic encryption may include different types of homomorphic encryption, such as partial homomorphic encryption, somewhat homomorphic encryption, and fully homomorphic encryption, with each having varying levels of computation allowed on the encrypted data. For example, somewhat homomorphic encryption may allow for computation on the data packet only for a limited number of times while fully homomorphic encryption allows for computation for an unlimited number of times. In some embodiments, the system may determine the homomorphic encryption type to best suit the resource transaction at hand.

In some embodiments, the resource transaction details include sender information, wherein the sender information includes information of a sender associated with the sender device. The sender information may include customer data of the sender, identifying information of the sender, the sender's registered mobile device information, or the like. In this way, the sender information may be used to verify the sender's identity along with the sender device. Further, the system may be able to determine that the sender is linked to the sender device by comparing the sender information against a public record database. The sender's mobile device information (e.g., a mobile device phone number) may be registered with the public database with a linkage to the sender's identifying information. For example, in the database, the sender's mobile device phone number may be linked to the sender's date of birth, social security number, address, driver's license number, or the like.

In some embodiments, the resource transaction details include receiver information, wherein the receiver information includes information of a receiver associated with the receiver device. The receiver information may include customer data of the receiver, identifying information of the receiver, the receiver's registered mobile device information, or the like. In this way, the receiver information may be used to verify the receiver's identity along with the receiver device. Further, the system may be able to determine that the receiver is linked to the receiver device by comparing the receiver information against a public record database. The receiver's mobile device information (e.g., a mobile device phone number) may be registered with the public database with a linkage to the receiver's identifying information. For example, in the database, the receiver's mobile device phone number may be linked to the receiver's date of birth, social security number, address, driver's license number, or the like.

In some embodiments, the resource transaction details include sender entity information, wherein the sender entity information includes information of a sender entity associated with the sender resource container. In some embodiments, the resource transaction details include receiver entity information, wherein the receiver entity information includes information of a receiver entity associated with the receiver resource container. In some embodiments, the sender entity and the receiver entity may be the same entity. For instance, if the sender resource container and the receiver resource container are associated with the same entity, the entity information may be the same for both the receiver and sender entity.

Both the sender entity information and the receiver entity information may include various types of identifiers and addresses that help in accurately directing the primary smart contract, data packet, encrypted data packet, or the like, to the appropriate location. The entity information (e.g., sender and receiver entity information) may include the entity name, physical address, internet protocol (IP) address, domain name, email address, or the like. In some embodiments, if the entity deals in financial transactions, the entity information may include a bank identifier code (BIC), SWIFT code, routing number, or the like. Additionally, or alternatively, the entity information may include a merchant identification, website uniform resource locator (URL), or the like.

As shown in block 206, the process flow 200 of this embodiment includes generating a secondary contract, wherein the secondary contract includes verifying the receiver device. Similar to the primary smart contract, as discussed above, the secondary smart contract may include a smart contract that automatically completes the terms set out in the contract. Additionally, or alternatively, the smart contract may include self-executing contracts with the terms of the agreement directly written into lines of code, which may be executed on a distributed ledger. Further, the secondary smart contract may be generated simultaneously when the primary smart contract is generated. For example, and as shown in FIG. 3, the primary smart contract 306 and the secondary smart contract 312 may be generated upon the transaction being initiated (as shown in block 302) by the sender device 304.

In some embodiments, the secondary contract further includes determining, using a public domain database, a match between the receiver information and the receiver device information. The public domain database may be used to check that the receiver and the receiver device are legitimate by using the receiver information and the receiver device information. For example, an individual (e.g., the receiver) may register their date of birth, SSN, address, or the like (e.g., the receiver information) in the database and register their mobile phone number (e.g., the receiver device information) in the database, as well. In this example, the system may determine a match exists because the system can determine a linkage between the receiver information and the receiver device information in the public domain database. As shown in FIG. 3, the secondary smart contract 312 may include using the public database 314 to perform the verification of the receiver device 316.

In this way, if the receiver and the receiver device are registered in the public domain database, the secondary smart contract may be satisfied. The public domain database may contain extensive records that are accessible through a form of public registration, which may include a local registration, state registration, federal registration, or the like. In some embodiments, the public domain database used may include LexisNexis, Dun & Bradstreet, Bureau of Labor Statistics, U.S. Securities and Exchange Commission EDGAR Database, Telecom Operator Databases, Whitepages, or the like. The public database chosen may include information relating to the sender, the sender device, the sender entity, the receiver, the receiver device, and the receiver entity.

In some embodiments, the secondary contract further includes, in response to the match, generate a verification interface, wherein the verification interface is transmitted to the sender device, and wherein the verification interface configures a graphical user interface of the sender device. In some embodiments, the verification interface may include a notification or the like on the sender device that shows the sender the verification of the receiver and receiver device. For example, as shown in FIG. 3, the secondary smart contract 312 may transmit an interface 324 (e.g., verification interface) to the sender device 304.

In some embodiments, the secondary contract further includes, in response to a mismatch, generate a declination interface, wherein the declination interface is transmitted to the sender device, and wherein the declination interface configures a graphical user interface of the sender device. The mismatch may include a situation where the receiver information and/or the receiver device information does not match the information in the public domain database. Additionally, or alternatively, there may be no linkage in the public domain database between the receiver information and the receiver device information. For example, if an individual has registered their SSN (e.g., the receiver information) in the public domain database, but has not registered and/or linked their mobile phone number (e.g., the receiver device information) within the public domain database, the system may generate a declination interface.

In some embodiments, the declination interface may include a notification or the like on the sender device that shows the receiver and receiver device have not been verified for the resource transaction. In some embodiments, the declination interface may include a manual override feature that allows the sender to continue with the resource transaction despite the declination. For example, as shown in FIG. 3, the secondary smart contract 312 may transmit an interface 324 (e.g., declination interface) to the sender device 304.

Further, the system may generate any number of additional smart contracts. The additional smart contracts may be generated simultaneously along with the primary and secondary smart contracts. In some embodiments, the additional smart contracts may be used for further verification of the receiver device by using an additional public domain database. For example, if the secondary smart contract uses LexisNexis for verification, a tertiary smart contract may use Telecom Operator Databases to verify the receiver further. The additional verification steps using the additional smart contracts may provide enhanced security and effectiveness to the system's operational capabilities. In cases where there are differing verification records from the smart contracts, the system may flag the incident for further review, and/or may block the transaction altogether. For example, if the secondary contract verifies the receiver as legitimate, but a tertiary contract declines the verification, the system may flag and block the transaction.

In some embodiments, the device verification system may include an artificial intelligence (AI) module that stores the mismatch and access the mismatch for future resource transactions comprising the receiver device, wherein the AI module includes a transaction analysis unit configured to monitor the resource transaction. The AI module storing the mismatches for future resource transactions may significantly streamline and enhance the efficiency and security of the system by knowing which receivers may be deemed unsafe recipients of future resource transactions. In some embodiments, the AI module's transaction analysis unit may include a legitimacy assessment of the intended receivers of resource transactions, which may measure uncertainty of the receiver based on previous transactions, current transaction details, transaction frequency associated with the receiver, transaction size associated with the receiver, unusual patterns of transactions, or the like. In this way, the analysis of the receiver's resource transaction history may provide insights as to the intent of the receiver. As shown in FIG. 3, the intelligent AI module 322 may receive information from the secondary smart contract 312 and store that information for future transactions. Further, as shown in FIG. 3, the intelligent AI module 322 may communicate with the primary smart contract 306 and sender device 304 for updates on legitimacy assessments from its transaction analysis unit. In this way, and in some embodiments, the intelligent AI module 322 may enhance the security of the system by flagging and/or blocking receivers with uncertain intent.

For example, and in some embodiments, if the transaction analysis unit determines the receiver's current transaction match known historical and legitimate behaviors, the system may bypass additional verification steps (e.g., secondary smart contracts, tertiary smart contracts, or the like). In another example, and in some embodiments, if the transaction analysis unit determines the receiver's historical resource transactions include highly uncertain and unusual behavior patterns, the AI module may block the transaction, flag it for further review, send a declination interface, or the like.

As shown in block 208, the process flow 200 of this embodiment includes executing the resource transaction, wherein executing the resource transaction includes providing the data packet to the sender entity, and wherein the sender entity is associated with the sender resource container. In some embodiments, the data packet may be transmitted after the receiver has been verified through the secondary contract.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for verifying devices using advanced computational models for data analysis and automated processing, the system comprising:
a processing device;
a non-transitory storage device containing instructions when executed by the processing device, causes the processing device to perform the steps of:
initiate a resource transaction, wherein the resource transaction is initiated via a sender device, and wherein the resource transaction comprises transferring a resource from a sender resource container to a receiver resource container via the sender device and a receiver device;
generate a primary contract, wherein the primary contract comprises encrypting a data packet associated with the resource transaction and wherein the data packet comprises resource transaction details;
generate a secondary contract, wherein the secondary contract comprises verifying the receiver device; and
execute the resource transaction, wherein executing the resource transaction comprises providing the data packet to a sender entity, and wherein the sender entity is associated with the sender resource container.

2. The system of claim 1, wherein the primary contract further comprises encrypting the data packet using homomorphic encryption.

3. The system of claim 1, wherein the resource transaction details comprise:
sender information, wherein the sender information comprises information of a sender associated with the sender device;
receiver information, wherein the receiver information comprises information of a receiver associated with the receiver device;
sender entity information, wherein the sender entity information comprises information of the sender entity associated with the sender resource container; and
receiver entity information, wherein the receiver entity information comprises information of a receiver entity associated with the receiver resource container.

4. The system of claim 3, wherein the secondary contract further comprises determining, using a public domain database, a match between the receiver information and receiver device information.

5. The system of claim 4, wherein the secondary contract further comprises, in response to the match, generating a verification interface, wherein the verification interface is transmitted to the sender device, and wherein the verification interface configures a graphical user interface of the sender device.

6. The system of claim 4, wherein the secondary contract further comprises, in response to a mismatch, generating a declination interface, wherein the declination interface is transmitted to the sender device, and wherein the declination interface configures the graphical user interface of the sender device.

7. The system of claim 6, wherein an artificial intelligence (AI) module stores the mismatch and accesses the mismatch for future resource transactions comprising the receiver device, wherein the AI module comprises a transaction analysis unit configured to monitor the resource transaction.

8. The system of claim 1, wherein the resource transaction comprises a distributed ledger.

9. A computer program product for verifying devices using advanced computational models for data analysis and automated processing, the computer program product comprising a non-transitory computer-readable medium comprising code causing an apparatus to:
initiate a resource transaction, wherein the resource transaction is initiated via a sender device, and wherein the resource transaction comprises transferring a resource from a sender resource container to a receiver resource container via the sender device and a receiver device;
generate a primary contract, wherein the primary contract comprises encrypting a data packet associated with the resource transaction and wherein the data packet comprises resource transaction details;
generate a secondary contract, wherein the secondary contract comprises verifying the receiver device; and
execute the resource transaction, wherein executing the resource transaction comprises providing the data packet to a sender entity, and wherein the sender entity is associated with the sender resource container.

10. The computer program product of claim 9, wherein the primary contract further comprises encrypting the data packet using homomorphic encryption.

11. The computer program product of claim 9, wherein the resource transaction details comprise:
sender information, wherein the sender information comprises information of a sender associated with the sender device;
receiver information, wherein the receiver information comprises information of a receiver associated with the receiver device;
sender entity information, wherein the sender entity information comprises information of the sender entity associated with the sender resource container; and
receiver entity information, wherein the receiver entity information comprises information of a receiver entity associated with the receiver resource container.

12. The computer program product of claim 11, wherein the secondary contract further comprises determining, using a public domain database, a match between the receiver information and receiver device information.

13. The computer program product of claim 12, wherein the secondary contract further comprises, in response to the match, generating a verification interface, wherein the verification interface is transmitted to the sender device, and wherein the verification interface configures a graphical user interface of the sender device.

14. The computer program product of claim 12, wherein the secondary contract further comprises, in response to a mismatch, generating a declination interface, wherein the declination interface is transmitted to the sender device, and wherein the declination interface configures the graphical user interface of the sender device.

15. The computer program product of claim 14, wherein an artificial intelligence (AI) module stores the mismatch and accesses the mismatch for future resource transactions comprising the receiver device, wherein the AI module comprises a transaction analysis unit configured to monitor the resource transaction.

16. A method for verifying devices using advanced computational models for data analysis and automated processing, the method comprising:
initiating a resource transaction, wherein the resource transaction is initiate via a sender device, and wherein the resource transaction comprises transferring a resource from a sender resource container to a receiver resource container via the sender device and a receiver device;
generating a primary contract, wherein the primary contract comprises encrypting a data packet associated with the resource transaction and wherein the data packet comprises resource transaction details;
generate a secondary contract, wherein the secondary contract comprises verifying the receiver device; and
executing the resource transaction, wherein executing the resource transaction comprises providing the data packet to a sender entity, and wherein the sender entity is associated with the sender resource container.

17. The method of claim 16, wherein the primary contract further comprises encrypting the data packet using homomorphic encryption.

18. The method of claim 16, wherein the resource transaction details comprise:
sender information, wherein the sender information comprises information of a sender associated with the sender device;
receiver information, wherein the receiver information comprises information of a receiver associated with the receiver device;
sender entity information, wherein the sender entity information comprises information of the sender entity associated with the sender resource container; and
receiver entity information, wherein the receiver entity information comprises information of a receiver entity associated with the receiver resource container.

19. The method of claim 18, wherein the secondary contract further comprises determining, using a public domain database, a match between the receiver information and receiver device information.

20. The method of claim 19, wherein the secondary contract further comprises, in response to the match, generating a verification interface, wherein the verification interface is transmitted to the sender device, and wherein the verification interface configures a graphical user interface of the sender device.
